(19) United States
(12) Patent Application Publication
(10) Pub. No.: US 2026/0343128 A1
(43) Pub. Date: Oct. 29, 2026

(54) SPEAKER

(71) Applicant: AAC Microtech (Changzhou) Co., Ltd., Changzhou City (CN)

(72) Inventors: Jinming Li, Changzhou (CN); Wei Wei, Changzhou (CN); Huhu Yang, Changzhou (CN)

(21) Appl. No.: 19/294,360

(22) Filed: Aug. 8, 2025

Related U.S. Application Data
(63) Continuation of application No. PCT/CN2025/091979, filed on Apr. 29, 2025.

(51) Int. Cl. H04R 1/06; H04R 7/18; H04R 9/02; H04R 9/06

(52) U.S. Cl. CPC H04R 1/06; H04R 7/18; H04R 9/025; H04R 9/06; H04R 2400/11

(57) ABSTRACT

The present disclosure discloses a speaker including a frame, a vibration system including a coil and a diaphragm, a magnet system including a yoke having a first opening penetrating thereon and a magnet assembly. The magnet system includes main magnet. The main magnet includes a second opening opposite and connected to a first opening on the yoke, a bending portion of the second FPC extends through the second opening, a fourth electrical connection portion of the second FPC is fixed on a side of the yoke away from the diaphragm to be electrically connected with an external circuit. The speaker in the present disclosure has lower cost, more simple manufacture process and more stable acoustic performance.

### SPECIFICATION

### FIELD OF THE PRESENT DISCLOSURE

The present disclosure relates to electric-acoustic conversion technologies, especially relates to a speaker applied in portable mobile terminals.

### DESCRIPTION OF RELATED ART

Speaker is widely applied portable mobile devices such as mobile phones, earphones and laptops.

In related art, the speaker commonly includes a frame, vibration system and a magnet system mounted on the frame. The vibration system includes a diaphragm generated acoustic signal and a coil driven the diaphragm via interaction with the magnet of the magnet system. The magnet system includes an opening penetrating thereon which is opposite to the vibration force arm of the vibration system and the flexible printed circuit board (FPC) electrically connected with the coil. In order to electrically connect the FPC with external circuit, the bonding pad of the FPC should be lead out to the outer surface of the yoke. In related art, the bonding pad is electrically lead out by injecting resin and metal connector into the opening of the magnet system. However, said injection process is relatively complex and its cost is high. Besides, the resin material adopted in injection process is prone to penetrate into the magnet system and the vibration system, therefore reducing the acoustic performance of the speaker.

Therefore, it is necessary to provide an improved speaker to overcome the problems mentioned above.

### SUMMARY OF THE INVENTION

One object of the present disclosure is to provide a speaker with lower cost, more simple manufacture process and higher acoustic performance.

The speaker includes a hollow housing including a frame with a receiving space; a vibration system mounted on the frame, including: a diaphragm mounted on the frame and configured to vibration along a vibration direction; and a coil fixed on the diaphragm; a magnet system with a magnetic gap, including: a yoke mounted on the frame, including a first opening penetrating thereon and an inner edge enclosed the first opening; and a magnet assembly disposed on a side of the yoke facing the diaphragm, including an annular main magnet disposed on the inner edge; a first flexible printed circuit (FPC) electrically connected with the coil, including: a first electrical connection portion fixed on a side of the diaphragm facing the yoke; a second electrical connection portion opposite the first opening along the vibration direction; and an elastic portion connected the first electrical connection portion and the second electrical connection portion; a second FPC electrically connected with the first FPC, including: a third electrical connection portion electrically connected to the second electrical connection portion; a bending portion bended from the third electrical connection portion and extended along a direction away from the diaphragm; and a fourth electrical connection portion extended from the bending portion; wherein the main magnet comprises a second opening opposite and connected to the first opening, the bending portion extends through the second opening and is configured to be spaced apart from the main magnet, the fourth electrical connection portion is fixed on a side of the yoke away from the diaphragm to be electrically connected with an external circuit.

As an improvement, further including a steel plate fixed on a side of the second FPC away from the diaphragm along the vibration direction; the steel plate includes a first strengthen portion fixed on the third electrical connection portion, a second strengthen portion fixed on the bending portion, and a third strengthen portion; the third strengthen portion includes a first strengthen segment fixed on the fourth electrical connection portion, and a second strengthen segment extended from the first strengthen segment; the second strengthen segment is fixed on a surface of the yoke away from the main magnet.

As an improvement, a projection of the main magnet along the vibration direction is rectangular; the main magnet further includes an inner side wall enclosed the second opening; the inner wall includes two first side walls opposite to each other along a short axis direction; the bending portion is parallel and opposite to each of the two first side walls at an interval; the second strengthen portion is fixed on a surface of the bending portion away from the two first side walls.

As an improvement, the yoke includes a concave portion depressed towards the diaphragm along the vibration direction; the fourth electrical connection portion is received in the concave portion; along the vibration direction, a depth of the concave portion is larger than a thickness of the fourth electrical connection portion.

As an improvement, the diaphragm includes a central portion located at a central position, a holder surrounding the central portion, an edge portion surrounding the holder; the holder includes an flat portion connected the central portion with the edge portion; the flat portion is fixed on a surface of the central portion facing the main magnet; the first electrical connection portion is fixed on a surface of the flat portion away from the central portion.

As an improvement, the first FPC further includes a vertical portion bended from the first electrical connection portion and extended along a direction away from the diaphragm; two ends of the elastic portion are respectively fixed on the vertical portion and the second electrical connection portion.

As an improvement, a projection of the elastic portion along the vibration direction is wholly located inside the first opening.

As an improvement, the holder includes an extended portion bended from an inner edge of the flat portion and extended towards the yoke; the extended portion is located at a side of the vertical portion closer to the elastic portion; an end of the extended portion away from the flat portion is fixed on the elastic portion.

As an improvement, the magnet assembly further includes a main magnetic plate disposed on a surface of the main magnet facing the diaphragm; an avoiding notch is penetrated on the main magnetic plate along the vibration direction and opposite to the first electrical connection portion along the vibration direction.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiments described hereby is only to explain this disclosure, not intended to limit this disclosure.

FIG. 1 is an isometric view of a speaker in accordance with an exemplary embodiment of the present disclosure.

FIG. 2 is another isometric view of the speaker in FIG. 1.

FIG. 3 is an exploded view of the speaker in FIG. 1.

FIG. 4 is an isometric view of a first FPC, a second FPC, and a steel plate of the speaker in FIG. 1.

FIG. 5 is a cross-sectional view of the speaker taken along line A-A in FIG. 1.

FIG. 6 is a cross-sectional view of the speaker taken along line B-B in FIG. 1.

FIG. 7 is a top view of the speaker in FIG. 1 removing a diaphragm.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

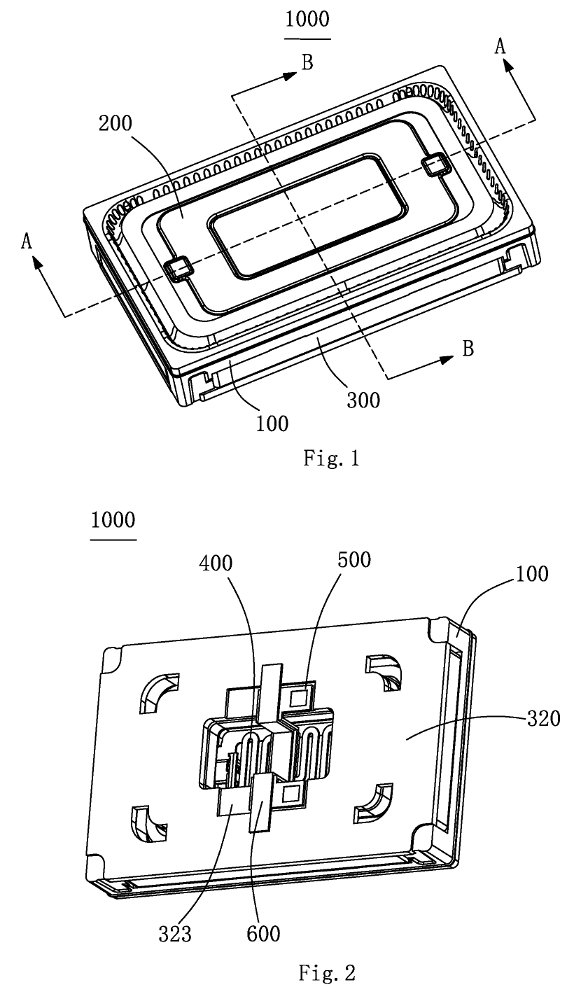

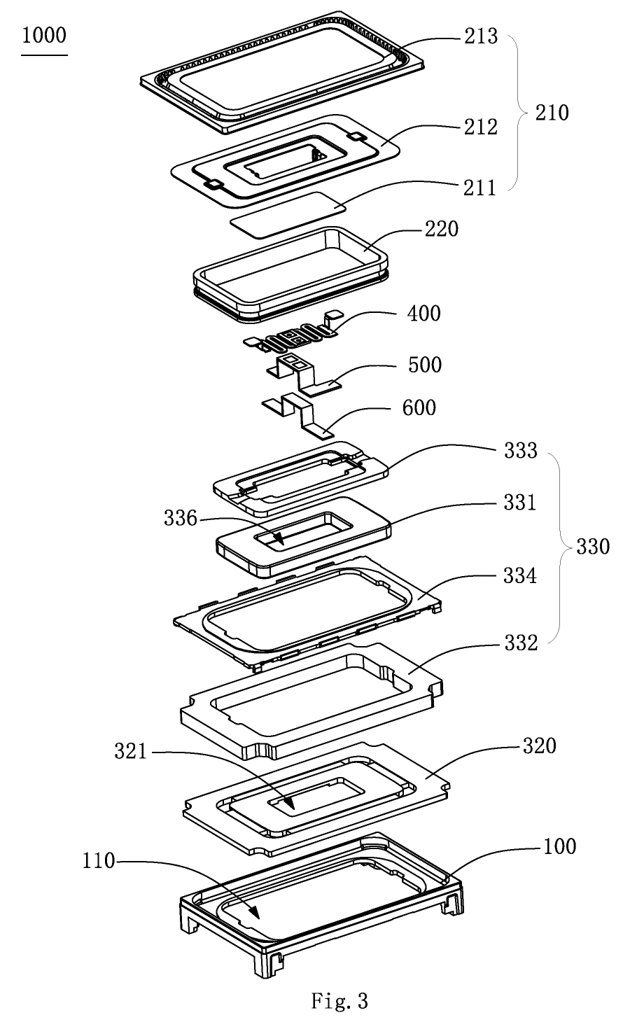

Please refer to FIGS. 1-3 together, a speaker 1000 provided by an exemplary embodiment of the present disclosure includes a frame 100 with a receiving space 110, a vibration system 200 mounted on the frame 100, and a magnet system 300 with a magnetic gap 310. The vibration system 200 and the magnet system 300 are both received in the receiving space 110 of the frame 100.

As shown in FIGS. 1-5, a vibration system includes a diaphragm 210 mounted on the frame 100 and configured to vibration along a vibration direction, and a coil 220 fixed on the diaphragm 210. Furthermore, the diaphragm 210 includes a central portion 211 located at a central position, a holder 212 surrounding the central portion 211, an edge portion 213 surrounding the holder 212. The holder 212 includes an flat portion2121 connected the central portion 211 with the edge portion 213. To be specific, the flat portion 2121 is fixed on a surface of the central portion 211 facing the magnet system 30. In one embodiment, it should be noted that the holder 212 and the edge portion 213 are both rectangular ring shape. And, the inner edge of the edge portion 213 is fixed on the flat portion 2121 of the holder 212, the outer edge of the edge portion 213 is mounted on the frame 100.

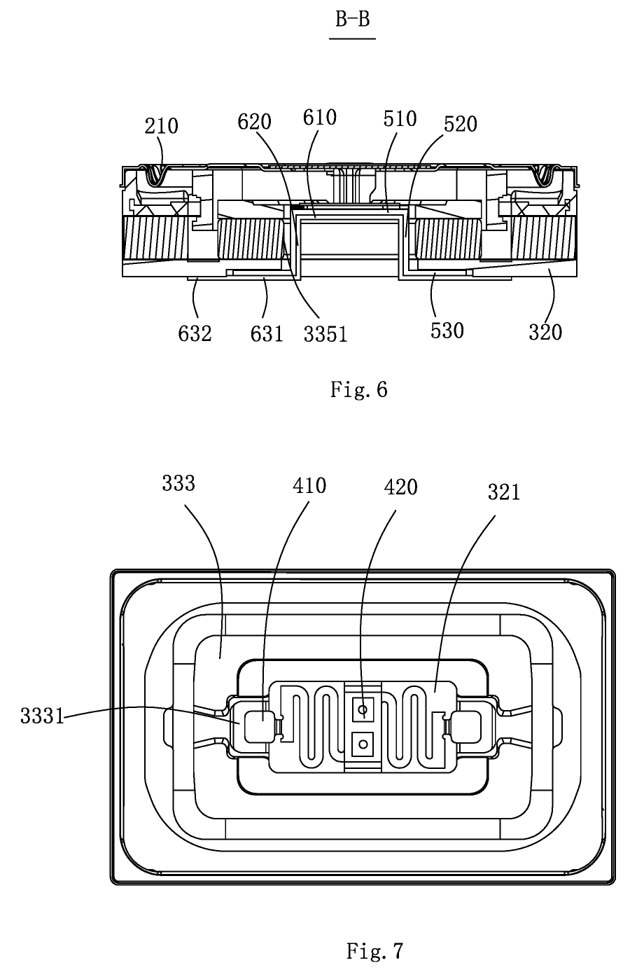

As shown in FIGS. 3-6, the magnet system 300 includes a yoke 320 mounted on the frame 100, and a magnet assembly 330 disposed on a side of the yoke 320 facing the diaphragm 210. Specifically, the magnet assembly 330 includes a main magnet 331 disposed on yoke 320, a side magnet 332 spaced apart from the main magnet 331 forming the magnetic gap 310, a main magnetic plate 333 disposed on a surface of the main magnet 331 facing the diaphragm 210, and a side magnetic plate 334 disposed on a surface of the side magnet 332 facing the diaphragm 210. The coil 220 is inserted into the magnetic gap 310.

In one embodiment, the yoke 320 includes a first opening 321 penetrating thereon along the vibration direction and an inner edge 322 enclosed the first opening 321. Correspondingly, the main magnet 331 is also rectangular ring shape. The main magnet 331 includes a second opening 336 penetrating there on which is opposite and connected to the first opening 321. Furthermore, the main magnet 331 is disposed on the inner edge 322 but does not be exposed outside through the first opening 321.

Moreover, the speaker 1000 includes a first flexible printed circuit (FPC) 400 electrically connected with the coil 220, and a second FPC 500 electrically connected with the first FPC 400. The second FPC is electrically connected to external circuit to electrically activate the coil 220.

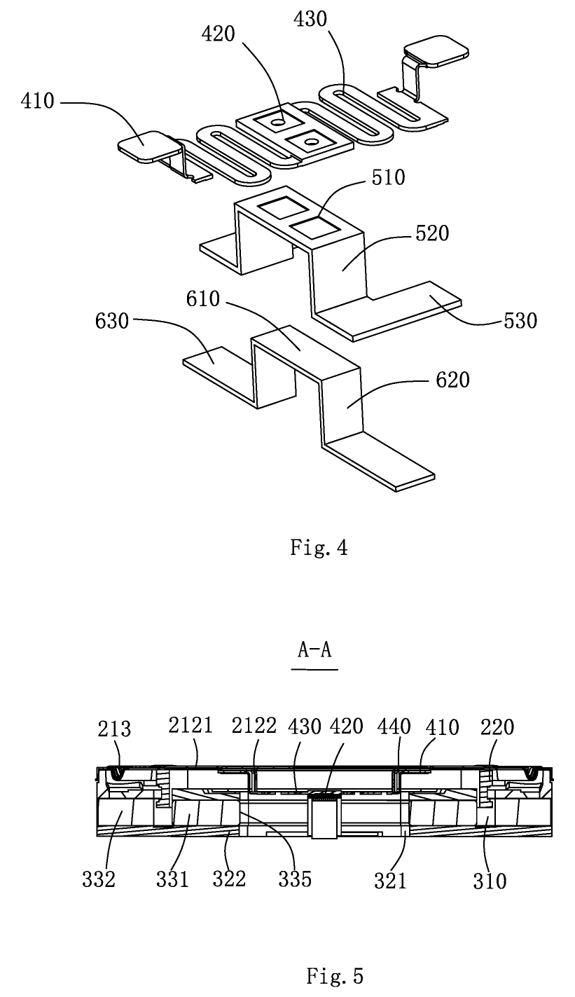

As shown in FIGS. 4-7, the first FPC 400 includes a first electrical connection portion 410 fixed on a side of the diaphragm 210 facing the yoke 320, a second electrical connection portion 420 opposite the first opening 321 along the vibration direction, and an elastic portion 430 connected the first electrical connection portion 410 and the second electrical connection portion 420. A projection of the elastic portion 430 along the vibration direction is wholly located inside the first opening 321, thus effectively avoiding the collision between the elastic portion 430 and the magnet system 300 during vibration of the diaphragm 210 and then improving the acoustic stability of the vibration system 200.

Furthermore, the first FPC 400 further includes a vertical portion 440 bended from the first electrical connection portion410 and extended along a direction away from the diaphragm 210. Two ends of the elastic portion 430 are respectively fixed on the vertical portion 440 and the second electrical connection portion 420. The first electrical connection portion 410 is fixed on a surface of the flat portion 2121 away from the central portion 211. Additionally, the holder 212 further includes an extended portion 2122 bended from an inner edge of the flat portion 2121 and extended towards the yoke 320. The extended portion 2122 is located at a side of the vertical portion 440 closer to the elastic portion 430. An end of the extended portion 2122 away from the flat portion 2121 is fixed on the elastic portion 430 for further supporting the elastic portion 430 and improving the stability of the first FPC400. In one embodiment, the number of the first electrical connection portion 400 is two. The two first electrical connection portions 410 are respectively welded to output end and input end of the coil 220. Besides, the number of the elastic portion 430 is two. The second electrical connection portion 420 is located between the two first electrical connection portions 410. Two ends of the second electrical connection portion 420 are respectively connected to respective one of the two elastic portions 430.

In one embodiment, an avoiding notch 3331 is penetrated on the main magnetic plate 333 along the vibration direction and opposite to the first electrical connection portion 410 along the vibration direction. During vibration of the diaphragm 210 along the vibration direction, the avoiding notch 3331 is provided to prevent the noise resulted from the collision between the first electrical connection portion 410 and the main magnetic plate 333, thus ensuring the stable acoustic performance of the speaker 1000.

Furthermore, the second FPC 500 includes a third electrical connection portion 510 electrically connected to the second electrical connection portion 420, a bending portion 520 bended from the third electrical connection portion 510 and extended along a direction away from the diaphragm 210, and a fourth electrical connection portion 530 extended from the bending portion 520. The bending portion 520 extends through the second opening 336 and is configured to be spaced apart from the main magnet 331. The fourth electrical connection portion 530 is fixed on a side of the yoke 320 away from the diaphragm 210 to be electrically connected with an external circuit.

As shown in FIGS. 4-7, a projection of the main magnet 331 along the vibration direction is rectangular. the main magnet 331 further includes an inner side wall 335 enclosed the second opening 336. The inner wall 335 includes two first side walls 3351 opposite to each other along a short axis direction. The bending portion 520 is parallel and opposite to each of the two first side walls 3351 at an interval. In one embodiment, the second FPC 400 includes two bending portions 520 respectively connected to two ends of the third electrical connection portion 510.

The yoke 320 includes a concave portion 323 depressed towards the diaphragm 210 along the vibration direction. The fourth electrical connection portion 530 is received in the concave portion 323 along the vibration direction. A depth of the concave portion 323 is larger than a thickness of the fourth electrical connection portion 530, thus preventing the fourth electrical connection portion 530 from protruding the outer surface of the yoke 320 and then reducing the thickness of the speaker 1000.

Moreover, the speaker 1000 includes a steel plate 600 fixed on a side of the second FPC 500 away from the diaphragm 210 along the vibration direction. The steel plate 600 includes a first strengthen portion 610 fixed on the third electrical connection portion 510, a second strengthen portion 620 fixed on the bending portion 520, and a third strengthen portion 630. The third strengthen portion 630 includes a first strengthen segment 631 fixed on the fourth electrical connection portion 530, and a second strengthen segment 632 extended from the first strengthen segment 631. The second strengthen segment 632 is fixed on a surface of the yoke 320 away from the main magnet 331. The second strengthen portion 620 is fixed on a surface of the bending portion 520 away from the first side wall 3351.

Compared with the related art, in the speaker in the present disclosure, the second FPC extends through the first opening on the yoke and the second opening on the main magnet to electrically connect external circuit with the first FPC, and the first FPC is electrically with the coil. In this manner, the manufacture process is simplifies, thus not only reducing the cost of the speaker and improving the production yield rate, but also ensuring the stable acoustic performance of the speaker.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker comprising:
a frame with a receiving space;
a vibration system mounted on the frame, comprising:
a diaphragm mounted on the frame and configured to vibration along a vibration direction; and
a coil fixed on the diaphragm;
a magnet system with a magnetic gap, comprising:
a yoke mounted on the frame, including a first opening penetrating thereon and an inner edge enclosed the first opening; and
a magnet assembly disposed on a side of the yoke facing the diaphragm, including an annular main magnet disposed on the inner edge;
a first flexible printed circuit (FPC) electrically connected with the coil, comprising:
a first electrical connection portion fixed on a side of the diaphragm facing the yoke;
a second electrical connection portion opposite the first opening along the vibration direction; and
an elastic portion connected the first electrical connection portion and the second electrical connection portion;
a second FPC electrically connected with the first FPC, comprising:
a third electrical connection portion electrically connected to the second electrical connection portion;
a bending portion bended from the third electrical connection portion and extended along a direction away from the diaphragm; and
a fourth electrical connection portion extended from the bending portion;
wherein
the main magnet comprises a second opening opposite and connected to the first opening, the bending portion extends through the second opening and is configured to be spaced apart from the main magnet, the fourth electrical connection portion is fixed on a side of the yoke away from the diaphragm to be electrically connected with an external circuit.

2. The speaker as described in claim 1, further comprising a steel plate fixed on a side of the second FPC away from the diaphragm along the vibration direction; the steel plate comprises a first strengthen portion fixed on the third electrical connection portion, a second strengthen portion fixed on the bending portion, and a third strengthen portion; the third strengthen portion comprises a first strengthen segment fixed on the fourth electrical connection portion, and a second strengthen segment extended from the first strengthen segment; the second strengthen segment is fixed on a surface of the yoke away from the main magnet.

3. The speaker as described in claim 2, wherein a projection of the main magnet along the vibration direction is rectangular; the main magnet further comprises an inner side wall enclosed the second opening; the inner wall comprises two first side walls opposite to each other along a short axis direction; the bending portion is parallel and opposite to each of the two first side walls at an interval; the second strengthen portion is fixed on a surface of the bending portion away from the two first side walls.

4. The speaker as described in claim 1, wherein the yoke comprises a concave portion depressed towards the diaphragm along the vibration direction; the fourth electrical connection portion is received in the concave portion; along the vibration direction, a depth of the concave portion is larger than a thickness of the fourth electrical connection portion.

5. The speaker as described in claim 1, wherein the diaphragm comprises a central portion located at a central position, a holder surrounding the central portion, an edge portion surrounding the holder; the holder comprises an flat portion connected the central portion with the edge portion; the flat portion is fixed on a surface of the central portion facing the main magnet; the first electrical connection portion is fixed on a surface of the flat portion away from the central portion.

6. The speaker as described in claim 1, wherein the first FPC further comprises a vertical portion bended from the first electrical connection portion and extended along a direction away from the diaphragm; two ends of the elastic portion are respectively fixed on the vertical portion and the second electrical connection portion.

7. The speaker as described in claim 5, wherein a projection of the elastic portion along the vibration direction is wholly located inside the first opening.

8. The speaker as described in claim 6, wherein the holder comprises an extended portion bended from an inner edge of the flat portion and extended towards the yoke; the extended portion is located at a side of the vertical portion closer to the elastic portion; an end of the extended portion away from the flat portion is fixed on the elastic portion.

9. The speaker as described in claim 1, the magnet assembly further comprises a main magnetic plate disposed on a surface of the main magnet facing the diaphragm; an avoiding notch is penetrated on the main magnetic plate along the vibration direction and opposite to the first electrical connection portion along the vibration direction.
